(19) United States
(12) Patent Application Publication
(10) Pub. No.: US 2014/0069635 A1
(43) Pub. Date: Mar. 13, 2014

(54) EMULSIONS TO ENHANCE MICROBIAL ACTIVITY IN A RESERVOIR

(71) Applicant: Profero Energy Inc., Edinburgh (GB)

(72) Inventor: Johnny Mark Cordiner, Edinburgh (GB)

(21) Appl. No.: 13/951,365

(22) Filed: Jul. 25, 2013

Related U.S. Application Data
(60) Provisional application No. 61/676,264, filed on Jul. 26, 2012.

(51) Int. Cl. C09K 8/582

(52) U.S. Cl. CPC C09K 8/582
USPC 166/246

(57) ABSTRACT

The present application relates to methods of repressurizing petroleum reservoirs by increasing the rate of methane production.

### FIELD OF THE INVENTION

This invention is directed to emulsions useful for enhancing methanogenesis in a petroleum reservoir. The emulsions provide for means to control release of nutrients to the methanogenic consortium. This invention is also directed to methods for enhancing methanogenesis in petroleum reservoirs as well as methods for repressurization of spent reservoirs.

### BACKGROUND OF THE INVENTION

### State of the Art

Spent subsurface oil reservoirs retain about 60% of the original volume of the oil deposit. Such spent reservoirs include those where primary, secondary and/or tertiary recovery means have been exhausted to the point that further recovery of oil from the reservoir is no longer economical.

One of the limiting factors in recovering any of the remaining oil from the spent reservoir is the lack of pressurization above the remaining non-recovered oil. The ability to recover this remaining oil is highly desirable given the continuing depletion of oil reserves worldwide. Oil recovery from most petroleum reservoirs is gas-driven. That is to say that the when first tapped, the pressure from the gas cap above the oil provides sufficient force to allow surface collection of the oil from the reservoir. Such reservoirs, when spent, would be excellent candidates for repressurization by increasing the amount of gas in the gas cap either in a closed or open manner.

Repressurization of the reservoir is fraught with significant difficulties including at least some of the following:
The topography of the reservoir is uneven and there are areas within the reservoir which are not in direct gaseous communication with other areas. That is to say that sections of the gas cap over the oil deposit are isolated by solid earth outcroppings.
The vast majority of the methanogens reside in the oil-water interface which is approximately 2 meters deep. Prior attempts to enhance methanogenic activity involved addition of nutrient containing water to the reservoir, but such addition resulted in dissemination of the nutrients to water including water that is not in contact with the methanogens.
The addition of nutrient-containing water has a localized effect, as dispersion of the water into the foundation water rapidly dilutes the concentration of nutrients, thereby reducing their effectiveness.

It would be particularly beneficial to provide compositions and methods for repressurization of spent reservoirs such that, when repressurized, additional oil can be produced. Alternatively, it would also be beneficial if the methane generated by repressurization could be recovered as an energy source.

### SUMMARY OF THE INVENTION

In one aspect, this invention provides compositions and methods for enhancing methanogenesis in a petroleum reservoir thereby permitting repressurization of spent reservoirs.

In one of its composition aspects, this invention is directed to a stable emulsion wherein the water in said emulsion contains nutrients for methanogenic microorganisms. Emulsions suitable for use in this invention include both oil-in-water emulsions (O/W) and water-in-oil emulsions (W/O). In the O/W emulsion, oil is integrated into an excess of water thereby rendering the density of that emulsion closer to water than to oil. In the W/O emulsion, water is integrated into an excess of oil thereby rendering the density of that emulsion closer to oil than to water. In either case, the density of the emulsions will result in their residing near the bottom or the top of the oil-water interface in the reservoir.

In one of its method aspects, there is provided a method for enhancing methanogenesis in a petroleum reservoir containing methanogenic microorganisms which method comprises introducing a stable emulsion into at least a portion of the reservoir such that the emulsion resides proximate to an oil-water interface in the petroleum reservoir wherein the water in said emulsion comprises one or more nutrients for methanogenic microorganisms; and maintaining the emulsion under conditions wherein water released from the emulsion will provide nutrients to said microorganisms thereby enhancing methanogenesis within the reservoir.

In another of its method aspects, this invention provides for a method for repressurizing at least a portion of a spent petroleum reservoir containing methanogenic microorganisms which method comprises:
introducing a stable emulsion into at least a portion of the reservoir such that the emulsion resides proximate to an oil-water interface in the petroleum reservoir wherein the water in said emulsion comprises one or more nutrients for methanogenic microorganisms;
maintaining the emulsion under conditions wherein water released from the emulsion provides nutrients to said microorganisms thereby enhancing methanogenesis within the reservoir; and
allowing the methanogenesis to continue until the pressure within at least a portion of the reservoir is sufficient to allow recovery of petroleum.

In some embodiments, the methods include measuring the increase in pressure exerted by the increase in methane in the reservoir.

In some embodiments, introducing the emulsion is accomplished by forming the emulsion inside the petroleum reservoir. In such an embodiment, water containing methanogenic nutrients is introduced under conditions such that it will interact with the endogenous oil to form a stable emulsion. Such conditions include injection of the water under agitating conditions and/or including components in the injected water that will facilitate formation of the emulsion. Such components are well known in the art and include co-solvents, emulsion stabilizers (e.g. surfactants), phase transfer catalysts, buffers, and the like. Provided surfactants are either non-toxic to the microorganisms or are at a concentration that is non-toxic to the microorganisms. In preferred embodiments, the surfactant does not contain acetate.

In some embodiments, the emulsion is first formed outside of the reservoir and then introduced into the reservoir. The preformed emulsion will collect and reside proximate to the water-oil interface due to density considerations. In a preferred embodiment, the emulsion is injected using horizontal injection techniques to facilitate placement of the emulsion at the water-oil interface.

In some embodiments, the methods of this invention further include introducing a second emulsion having a different density than the first emulsion so that the first and second emulsions reside at different sites proximate to the water-oil interface. In one preferred embodiment, the first emulsion can be a W/O emulsion and the second emulsion can be an O/W emulsion. The use of such a pair of emulsions having different densities affords both a floor and a ceiling within the water-oil interface.

In some embodiments, introducing the second emulsion is accomplished by forming the second emulsion outside of the petroleum reservoir and injecting the second emulsion proximate to the oil-water interface. In some embodiments, introducing the second emulsion is accomplished using horizontal injection.

In some embodiments, the second emulsion is an oil-in-water emulsion. In some embodiments, the first and second emulsions exhibit low gas permeability. Such is particularly beneficial in localized repressurization where these emulsions form a growing gas cap under the second (upper) emulsion. This gas cap, trapped by the upper emulsion, greatly decreases the time for which the localized gas cap will exhibit sufficient force to allow surface recovery of the petroleum.

In some embodiments, the one or more nutrients comprise ammonium ions (NH₄⁺) and/or phosphate ions (PO₄³⁻). In some embodiments, the one or more nutrients in the second emulsion also comprise ammonium ions (NH₄⁺) and/or phosphate ions (PO₄³⁻). In some embodiments, the concentration of nutrients in the first emulsion can range from about 1 ppm up to the saturation point of the nutrient. In some embodiments, concentration of nutrients in the second emulsion can range from about 1 ppm up to the saturation rate of the nutrient.

In some embodiments, the first emulsion further comprises a phase-transfer catalyst. In some embodiments, the second emulsion further comprises a phase-transfer catalyst. The phase-transfer catalyst can act to facilitate incorporation of specific components from the emulsion into either the water or oil in the water-oil interface.

In some embodiments, the densities of the oil layer, the oil-water interface, and the water layer are known or estimated within +/−10%. In some embodiments, the first emulsion has a defined density such that the first emulsion is localized proximate to the upper surface of the oil-water interface. In some embodiments, the second emulsion has a defined density such that the second emulsion is localized proximate to the lower surface of the oil-water interface.

In some embodiments, the local rock topography proximate to the site of the first and second emulsions is sufficiently gas impermeable such as to create a localized gas cap. In such embodiments, when the consortium produces methane, the local pressure increases sufficiently to allow extraction of oil from the area.

The summary of the invention described above is non-limiting and other features and advantages of the invention will be apparent from the following detailed description of the invention, and from the claims.

### BRIEF DESCRIPTION OF THE DRAWINGS

FIG. 1 shows a diagram of the various microbial mediated pathways that convert hydrocarbons to methane via an acetate intermediate, as well as pathways that degrade methane and acetate.

FIG. 2A shows a graph of cumulative ¹⁴C hexadecane conversion to methane after incubation with methanogenic microorganisms for 181 days in the presence of various concentrations of nutrients. FIG. 2B shows a graph of cumulative ¹⁴C hexadecane conversion to methane after incubation with methanogenic microorganisms for 181 days in the presence of various concentrations of nutrients.

### DETAILED DESCRIPTION OF THE INVENTION

### Definitions

As used in the specification and claims, the singular form “a”, “an” and “the” include plural references unless the context clearly dictates otherwise.

As used herein, the term “about” when used in association with a measurement, or used to modify a value, a unit, a constant, or a range of values, refers to variations of +/−3%. It is to be understood, although not always explicitly stated, that all numerical designations are preceded by the term “about”. Accordingly, all numerical designations, e.g., pH, temperature, time, concentration, and molecular weight, including ranges, are approximations which are varied (+) or (−) by increments of 3%. It also is to be understood, although not always explicitly stated, that the reagents described herein are merely exemplary and that equivalents of such are known in the art.

The term “ppm” or “parts per million” as used herein refers to the mass ratio of solutes to water multiplied by one million. 1 ppm is equivalent to 1 mg/L.

The terms “methanogenic microorganisms” or “methanogenic microbes” refer to those microbes or combination of microbes that produce methane from oil in hydrocarbon reservoirs. Such microbes are anaerobic and, accordingly, exogenous oxygen is contra-indicated during any injection. Methanogenic microbes are well known in the art and include, by way of example only, Methanocalculus spp., Methanogenium spp., Methanoculleus spp., members of the Methanosarcinales (all methanogenic archea), and associated syntrophic organisms providing acetate and hydrogen for the methanogens, including Syntrophus spp., Smithella spp. Marinobacter spp., Syntrophobacter spp., Syntrophomonas spp. (all syntrophic bacterial partners that may convert hydrocarbons to substrates for methanogenic archaea) and the like. Such microorganisms are sometimes referred in the plural as a “microbial consortium”.

The term “non-lethal” means that, after addition of the stimulant solution and optionally the inhibitor solution, a viable population of methanogenic microbes remain in the formation water.

The term “nutrient” or “methanogenic nutrient” (also referred to herein as “stimulant”) refers to a component or mixture of components such as gases, inorganic or organic ions including anions, cations and combinations thereof (salts) which facilitate growth of one or more methanogenic microbes. To facilitate growth, the nutrients can supply one or more key nutritional components to one or more of the microbes comprising the consortium of methanogenic microbes. The nutrient can be either an endogenous nutrient already present in the formation water or an exogenous nutrient—one which is not present in the formation water.

In one embodiment, the nutrient is an inorganic salt and more preferably is an inorganic salt selected from one or more of NH₄Cl, KH₂PO₄, FeSO₄.7H₂O, MnCl₂.4H₂O, CoCl₂.6H₂O, NiCl₂.6H₂O, CuCl₂.2H₂O, ZnSO4.7H₂O, Na₂MoO₄.H₂O, Na₂SeO₃.5H₂O, Na₂WO₄.2H₂O, POx compounds where x is 2, 3 or 4, Na₃PO₄, K₃PO₄, KH₂PO₄, K₂HPO₄, NaH₂PO₄, Na₂HPO₄, H₃PO₄, H₃PO₃, H₃PO₂, C₁-C₂₀ alkyl phosphate compounds, (C₁-C₂₀)₃trialkyl phosphate such as triethyl phosphate), tripoly phosphates, condensed forms of phosphoric acid, including tripolyphosphoric acid, pyrophosphoric acid, salts of condensed phosphoric acids, e.g., potassium or sodium tripolyphosphate, and the like. Both hydrated and anhydrous forms may be used.

Components heretofore considered as nutrients have been found to deleterious to methanogenesis and in a preferred embodiment are excluded from the nutrient composition. Such components include sulfate, nitrate, nitrite, and oxygen.

The term “inhibitor” refers to a component or mixture of components such as inorganic or organic compounds including anions, cations and combinations thereof (salts) which inhibit one or more microbial reactions which either degrade methane and/or inhibit one or more reactions which divert the petroleum components in the reservoir into products other than methane (“competing reactions”). Such inhibitors can be components that interfere with one or more of these competing reactions or which are selectively toxic to non-methanogenic microbes. Preferably, such inhibitors are one or more components that interfere with such competing reactions. In a preferred embodiment, the inhibitor is an inorganic salt and more preferably is a molybdate salt such as sodium molybdate (Na₂MoO₄), and hydrates thereof which are inhibitors of sulfate reducers, and sodium chlorate (NaClO₃) for inhibiting nitrate reducers. The inhibitor can be either an endogenous inhibitor—one which is already present in the formation water or an exogenous inhibitor—one which is not present in the formation water.

The term “non-nutrient” refers to components which are not nutrients or inhibitors. Such non-nutrients include sodium chloride and other salts which affect the salinity of the water in the reservoir. In general, the microbes are adapted to the salinity of the formation water. The injection strategy seeks to maintain essentially the same gross salinity of the formation water after injection as was present prior to injection.

The term “petroleum reservoir” refers to all of the components of the reservoir including the gas cap, the hydrocarbon layer, the foundation water, and the water-oil interface. Preferred hydrocarbons are those rich in n-alkanes in reservoirs in the carbon number range 3 to 30 where natural biodegradation is occurring. Typically, n-alkanes represent up to a maximum around 10 weight percent of the petroleum components and typically petroleum/oils suitable for methanogenesis will have from 1-5% n-alkanes present. Especially preferred hydrocarbons will also contain an extended suite of homologous alkylbenzenes and alkyltoluenes. Oil viscosity can range from very low values (from 5 or 10 centipoise (cP) at 20° C.) to values as high as 7000 cP at reservoir conditions. Low values generally mean more reactive oils but higher values favor gas over oil production. While n-alkane rich oils are preferred, in many reservoirs oils without n-alkanes or alkybenzenes acceleration of natural methanogenesis is possible as the microorganisms have adapted to consumption of less desirable reactants.

“Formation water” refers to the water endogenously present in the reservoir and includes the cations, anions, soluble organics, and other components as well as its temperature, pH, salinity, etc.

“MCF” means one thousand (1,000) cubic feet.

“Incremental increase in methane per day” refers to the increase in methane production when the reservoir has been treated under conditions to stimulate methanogenesis and is measured when the rate of methanogenesis (as determined by the amount of methane produced per day at the well head) is at least 80% of the maximum rate of methane generated from the reservoir over a 60 day period and preferably over a 120 day period.

“Well head” refers generically to any well head in the reservoir. Reference to a single well head is not intended herein, as injection of stimulants and/or inhibitors can be conducted at a first well head and the methane produced by enhanced methanogenesis can be captured at the same or different well head in the reservoir.

“Emulsion” refers to a multiphase mixture of two or more immiscible liquids, one of which is the dispersed phase and one of which is the continuous phase. Emulsion technology is well known in the art. However, the emulsion to be used should not include those components, which have no nutrient value and which when present in sufficient concentrations are toxic to the methanogenic microorganisms. This includes surfactants and other toxic components.

“Oil-in-water emulsion” refers to an emulsion in which oil is the dispersed phase and water is the continuous phase. The term may be notated as “O/W”.

“Water-in-oil emulsion” refers to an emulsion in which water is the dispersed phase and oil is the continuous phase. The term may be notated as “W/O”.

“Stable-emulsion” refers to an emulsion in which the dispersed phase and the continuous phase are maintained over a period of at least 24 hours, but spontaneously or slowly separate over a period of between about 24 hours and 1 year or more. Preferably, the stable emulsion is one with a relatively well defined period between injection into the reservoir and separation. A stable emulsion may be maintained for a day, week, a month, or a year.

“Semi-stable emulsion” or “meso-stable emulsion” refers to an emulsion in which the dispersed phase and the continuous phase are maintained over a period of at least 1 minute, but spontaneously or slowly separate over a period of between about 1 minute up to, but not including, about 24 hours. Preferably, the semi-stable emulsion is one with a relatively well defined period between injection into the reservoir and separation. A semi-stable emulsion may be maintained for 1 minute, 5 minutes, 10 minutes, 30 minutes, 1 hour, 2 hours, 4 hours, 5 hours, 10 hours, 12 hours, or 23 hours.

“Oil-water interface” refers to the area of contact between the two immiscible liquids, oil and water. An oil-water interface in a petroleum reservoir may range between 0.5 to 5 meters of thickness, which separates the oil layer from the water layer.

“Phase transfer catalyst” refers to a catalyst that facilitates the migration of a reactant from one phase into another phase where the reaction occurs. In some embodiments, the reactant is a drop of oil. It is contemplated that the oil droplet will increase the surface area of the oil available to microorganisms at an oil-water interface in a formation. In a preferred embodiment, the oil droplets are micronic or sub-micronic in size.

### Emulsion Technology

This invention is predicated in part on the discovery that an emulsion can be used as a vehicle to deliver methanogenic nutrients directly to the water-oil interface so as to provide a continuous means of enhancing methanogenic activity during the time period when the emulsion breaks.

As is apparent, the density of the emulsion is such that an oil-in-water emulsion will be more dense than the oil but less dense than the water and, accordingly, will reside at or near the bottom of the water-oil interface. Likewise, a water-in-oil emulsion will be less dense than the water but more dense than the oil and, accordingly, will reside near the top of the water-oil interface. In either case, the nutrient carrying emulsion provides release of the nutrients directly in or near the oil-water interface where the great majority of the methanogens reside. This provides for site specific delivery of the emulsion to the oil-water interface with minimal dilution as seen with direct water injection.

Equally significant is that the emulsion will spread throughout the oil-water interface so as to maximize the delivery of nutrients in a consistent basis across the entire surface where the emulsion has spread. This feature eliminates the dilution effect of prior nutrient delivery methods and maximizes methane production.

In one embodiment, as the emulsion breaks, it releases the nutrient rich water immediately in the vicinity of the methanogenic consortium. A slowly releasing emulsion provides for a continuous release of nutrients over the period of time during which the emulsion breaks. This provides for prolonged enhanced methanogenic activity. In another embodiment, the water in the emulsion also contains one or more inhibitor compounds so as to maximize methane production.

Injection of Nutrients into Oil Reservoir

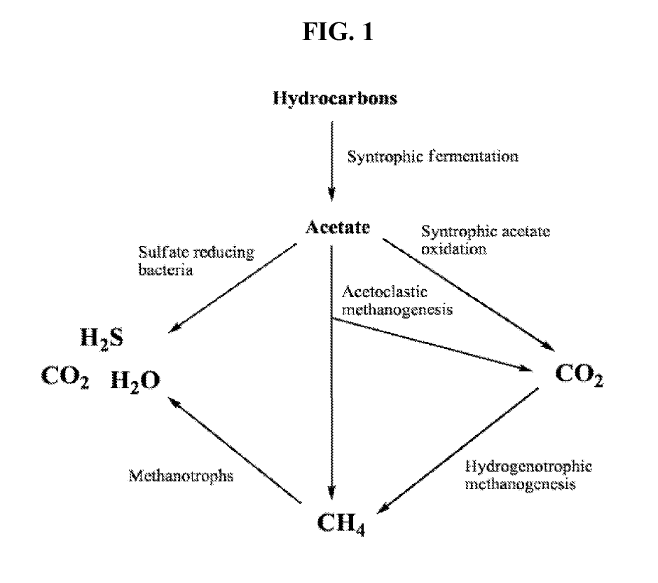

Referring to FIG. 1, methanogenic petroleum biodegradation in oil reservoirs proceeds primarily through syntrophic fermentation. Such biodegradation first leads to acetate and hydrogen as intermediates that are then utilized by various microorganisms for further biodegradation to methane. Microbes involved in the acetoclastic methanogenesis pathway convert acetate directly to methane (CH₄) and carbon dioxide (CO₂). Microbes in the syntrophic acetate oxidation pathway proceed to biodegrade acetate to carbon dioxide and hydrogen. The carbon dioxide is then reduced by microbes in the hydrogenotrophic methanogenesis pathway to methane. These microbes may co-exist with those that are adverse to methanogenesis such as sulfate reducing bacteria that metabolize acetate and hydrogen producing hydrogen sulfide (H₂S) water and CO₂ and methanotrophs that convert methane to various compounds including water and CO₂. The latter two are examples of “non-methane producing competing reactions” described above.

The present invention relates to methods for promoting microbial growth and activity that result in a substantial enhancement in the rate of production of methane (CH₄) in a subsurface oil reservoir.

Such enhancement can be effected by addition of one or more emulsions into the reservoir wherein the water component of the emulsions contain methanogenic nutrients and/or inhibitors.

A major factor in activating adequate subsurface organisms to produce methane over a large volume of subsurface reservoir is to deliver nutrient solutions, at a critical nutrient concentration (ConcA) to activate the microorganisms at a commercial rate, to as large a volume of reservoir as possible. The objective then becomes injecting or forming an emulsion adjacent to or in the water-oil interface wherein the water in the emulsion contains nutrients at the maximum safe concentration to avoid deactivating any key organisms when released (ConcH). In addition, the emulsion has the capacity of spreading rapidly throughout the water-oil interface so as to provide maximal coverage through the reservoir.

As a starting point, while preferred, it is not necessary to make a determination of the petroleum components and the endogenous microbes present in the reservoir. As the production of gas to repressurize the reservoir is the desired result, the addition or formation of nutrient enriched emulsions in the reservoir permits the addition of a wide range of nutrients for a wide range of microbes. Moreover, as the emulsion is limited in volume, the amount of nutrients added is likewise less than that compared to prior art techniques. Similarly, the amount of any optional inhibitors is likewise limited.

If it is desirable to ascertain the constituents of the reservoir prior to addition of the emulsion, factors to be considered include the type of petroleum components and microbes present and which nutrients and/or inhibitors should be used for that reservoir. Assays for determining the microbes present are known in the art including laboratory incubations of reservoir samples, culturing and culture independent analysis. Likewise, the mixture of hydrocarbons in the reservoir can be determined by conventional analytical means. In one embodiment, a single sample of hydrocarbons is used to determine the hydrocarbons present. In another, multiple samples are used to provide for a higher degree of certainty regarding the hydrocarbon components.

Nutrients and/or inhibitors for the microbes again can be preselected independent of any analysis or determined based on the microbe type or by laboratory incubations under different conditions.

Optionally, the selection of the appropriate nutrient(s) and/or inhibitor(s) as well as the total injected amount, rates of injection and injection points is then based on the size of the reservoir, the reservoir properties such as permeability and porosity and the amount and type of petroleum components present as well as the endogenous microbes and the presence of any non-nutrients. As to the size of the reservoir, determination of the field size, the water present, the concentration of nutrients and non-nutrients (e.g., salinity) already in the reservoir are well within the skill of the art.

However, as the nutrients and any optional inhibitors are included in an emulsion at the water-oil interface, selections as per above are merely preferred embodiments and the emulsion can be added directly or formed in situ without prior analysis of the reservoir. Such is possible as each emulsion acts as a discrete phase within the reservoir and is therefore independent of common factors such as dilution rates, salinity, etc.

The amount of nutrient (and/or inhibitors) included in the emulsion can exceed concentrations heretofore used for direct injection. Specifically, a slowly breaking emulsion will release only a fraction of the nutrient (and/or inhibitors) over a given period of time. Such emulsions therefore act in a semi-continuous manner to maintain release of the nutrients.

In a preferred embodiment, the emulsion is preformed and is added to the reservoir via injections made through a well head or a plurality of well heads. Such well heads are conventional well heads having access to the subsurface reservoir. The well head(s) for injection can be the same well head(s) for petroleum recovery. Alternatively, the well head(s) for petroleum recovery can be one or more well heads specifically dedicated to methane recovery.

In another embodiment, the phosphate ion concentrations for use in combination with the ammonium ions are chosen such that the molar ratio of nitrogen to phosphorus is approximately 10:1. Larger concentrations of phosphorus may be employed including nitrogen to phosphorus ratios of 9:1, 8:1, 7:1, and 6:1. The appropriate phosphorus concentration relative to the nitrogen concentration may be dependent on the particular phosphate reagent that is used and on the nature of the subsurface reservoir. In general the type and amount of phosphate chosen will minimize any precipitation of solids that is typically seen at higher phosphate concentrations.

In one embodiment, the nitrogen is provided by NH₄Cl. Other sources of nitrogen include ammonium phosphate. Naturally, in petroleum reservoirs, mean concentrations of ammonium ion range from a few ppm up to around 500 ppm, but are typically around a few tens of ppm. By contrast, in near surface anoxic environments (e.g., landfills), concentrations of ammonium ion range up to over 1000 ppm.

In one embodiment, the phosphate ion is provided by KH₂PO₄. Other sources of phosphate ions for use in the present methods include KH₂PO₄, NaH₂PO₄, Na₂HPO₄, and H₃PO₄ in anhydrous or hydrous form. The phosphate ion (PO₄³⁻) is preferably present in an amount of from 700 to 1400 ppm.

In one embodiment, the injected stimulants comprise ammonium, phosphate, nickel, and cobalt ions. It is understood, of course, that type and amount of the injected stimulants will be based on the presence and amount of stimulants already present in the reservoir.

In still other embodiments, one or more buffers are injected into the reservoir. Suitable buffers include carbonates (such as sodium carbonate, sodium bicarbonate, potassium carbonate, potassium bicarbonate) and alkali and alkaline earth hydroxides (such as LiOH, NaOH, KOH, Cs₂OH, Mg(OH)₂, and Ca(OH)₂). In one embodiment, the buffer is NaHCO₃. The amount of buffer to be added is dependent on the salinity and pH of the reservoir, which can vary from reservoir to reservoir.

In still other embodiments, one or more complexing agents are injected into the reservoir. Such agents include nitrilotriacetic acid. The complexing agents can be used to bind to the stimulants to prevent precipitation and aid in stabilizing the stimulant mixture, can act as inhibitors by binding to metals detrimental to methanogenesis, or act as a source of carbon or nitrogen for microbes to further facilitate biodegradation of oil and methanogenesis, or act as complexing agents to accelerate natural uptake of key nutrient elements from the host reservoir rock.

In yet other embodiments, one or more inhibitors that minimize microbial activity that slow or are detrimental to methanogenesis may be used. Inhibitors include those that inhibit the activity of iron-reducing, nitrate-reducing, or sulphate-reducing bacteria. Specific inhibitors include sodium molybdate (Na₂MoO₄) and hydrates of sodium molybdate for inhibiting sulfate reducers, and sodium chlorate (NaClO₃) for inhibiting nitrate reducers. Concentrations of sodium molybdate and sodium chlorate of about 20 mM are contemplated as suitable for use in this invention.

The stimulants (ammonium and phosphate ions, minerals, etc) inhibitors, buffers, and other agents may be combined together in one or more aqueous emulsions. In one embodiment, the ammonium and phosphate ions are contained in a single emulsion. The emulsion components may also be sparged with N₂ that will remove oxygen. In some embodiments the water used in the emulsions is the natural formation water from the reservoir.

In one embodiment, the total salinity of the injected solutions being added to the reservoir will have a salinity similar to that of the reservoir. The salinity of the solutions may be adjusted by modifying the amount of added salts such as NaCl and CaCl or other major ions present in the formation water naturally.

In some embodiments, the temperature of the emulsion is approximately the same as the temperature of the oil-water interface. The temperature may be estimated based on known parameters of the reservoir. Alternatively, the temperature may be directly determined, e.g. by measuring the temperature of the oil, water, and/or oil-water interface.

Without being bound by theory, the formulation is believed to promote growth of microbes in the syntrophic fermentation, acetoclastic methanogenesis, syntrophic acetate oxidation, and hydrogenotrophic pathways shown in FIG. 1. Microbes involved in methanogenic hydrocarbon degradation include methanogens from the Methanomicrobiales (Methanocalculus spp., Methanogenium spp., Methanoculleus spp.), Methanosarcinales and anaerobic hydrocarbon fermenting bacteria such as Smithella spp., Syntrophus spp., Syntrophobacter spp., Syntrophomonas spp., and Marinobacter spp.

In some embodiments, multiple injections of nutrient containing emulsions may be made in a given region over time. A nutrient-filled emulsion may be injected to produce methane and produce a local re-pressurization of the reservoir for extracting petroleum. If sufficient pressure is later lost, the local area may be reinjected with a nutrient emulsion to re-stimulate methane production.

While producing the methane gas, production parameters can be monitored including the pressure in the reservoir, gas production flow rate and composition of the produced gas. Based on the monitored production parameters, injection into and/or production from the zone are controlled to enhance production of petroleum from the zone.

Further descriptions of methods and systems for gas production in a reservoir are set forth in Canadian Patent Application No. 3,638,451 which is incorporated herein by reference in its entirety.

### Emulsions in the Oil-Water Interface

Consortia of methanogenic microorganisms are found in high concentrations near the oil-water interface, and introduction of nutrients near this interface is considered ideal for increasing the levels of methanogenesis of such consortia. Emulsions of oil-in-water or water-in-oil may be used to deliver nutrients, such as those described herein, to the oil-water interface. Emulsions of oil and water can be created, preferably without the use of surfactants. As the emulsion “breaks”, the colloidal droplets in the dispersed phase coalesce and separate from the continuous phase.

In one embodiment, a stable water-in-oil (W/O) emulsion is injected proximate to the oil-water interface in a petroleum reservoir. The W/O emulsion can be injected near the oil-water interface and close to the water layer. The water in the emulsion contains nutrients for methanogenic microorganisms as described herein. The W/O emulsion then disperses along the oil-water interface. As the water in the W/O emulsion undergoes coalescence and separates from the oil, the nutrient-filled water is made available to the microorganisms in the oil-water interface. Thus, nutrients can be supplied to the microorganisms steadily over time following the initial nutrient injection.

The nutrient injection causes a sufficient increase in methane production such that the methane gas migrates into the gas cap of the reservoir. Sufficient migration of methane into the gas cap results in repressurization of the reservoir.

In another embodiment, an oil-in-water (O/W) emulsion with nutrients solubilized in the water is injected proximate to the oil-water interface of a petroleum reservoir. The O/W emulsion can be injected near the oil-water interface and close to the oil layer. The water in the emulsion contains nutrients for methanogenic microorganisms as described herein. The O/W emulsion then disperses along the oil-water interface. As the oil in the O/W emulsion undergoes coalescence and separates from the water, the nutrient-filled water is made available to the microorganisms in the oil-water interface. Thus, nutrients can be supplied to the microorganisms steadily over time following the initial nutrient injection.

### Localized Repressurization

Localized repressurization of an oil reservoir using nutrient stimulation of methanogenic microorganisms has additional advantages over attempting to stimulate microorganisms in an entire reservoir. Nutrient injection used to repressurize an entire reservoir may require multiple injections in various sites throughout the reservoir. Using localized repressurization, oil production can be achieved without the need to create a reservoir-wide infrastructure of injection wells. In addition, being able to repressurize locally will result in faster oil production, with the potential to produce oil from multiple locations throughout the reservoir without fear of damaging reservoir pressure.

Localized repressurization can be accomplished by injecting nutrient-rich emulsions of oil and water in regions of the reservoir with a topography that can allow the formation of a closed system in a localized area.

In one embodiment using multiple emulsions, an emulsion (e.g. a W/O emulsion) is injected near the top portion of the oil-water interface of the reservoir (close to the oil layer), and an emulsion (e.g. an O/W emulsion) is injected near the bottom portion of the oil-water interface (close to the water layer). The emulsion at the top forms an expandable ceiling that fills with methane as it is produced. This creates a closed localized system defined by the emulsion and the topography of the reservoir. Methane produced is trapped by the upper emulsion and like a balloon, the gas expands the balloon until the pressure is such that the localized field renders the oil under this closed system recoverable. Once recovered, the process can be repeated in a cyclic manner to reduce the non-recoverable oil in the reservoir to a minimum.

In some embodiments, the density of the oil-water interface is known or is estimated given the geologic parameters of the reservoir. A person having ordinary skill in the art will be able to estimate this density or sample fluid from the oil-water interface to determine its density. The densities of the emulsions placed near the top and bottom of the oil-water interface can be adjusted to approximate the density of the oil-water interface.

### EXAMPLES

### Example 1

A 1 L aqueous solution of nutrients for reservoir injection was prepared using the following compounds:

| Nutrient | g/liter H₂O |
|---|---|
| MgCl₂ | 0.363543 |
| NH₄Cl | 0.066819 |
| KH₂PO₄ | 0.016991 |
| NaHCO₃ | 0.800235 |
| FeSO₄ | 2.65 × 10⁻⁵ |
| H₃BO₄ | 5.61 × 10⁻⁵ |
| MnCl₂ | 0.000914 |
| CoCl₂ | 0.000115 |
| NiCl₂ | 1.39 × 10⁻⁶ |
| CuCl₂ | 7.13 × 10⁻⁵ |
| ZnSO₄ | 1.97 × 10⁻⁵ |
| Na₂MoO₄ | 1.97 × 10⁻⁵ |
| Na₂SeO₃ | 4.38 × 10⁻⁶ |
| Na₂WO₄ | 6.28 × 10⁻⁵ |
| NaCl | 7 |
| CaCl₂ | 0.12 |
| NaH₂PO₄ | 0.175 |

### Example 2

The following solution was prepared with reservoir water from a Western Canadian sandstone heavy oil reservoir:

| Nutrient | per liter H₂O | |
|---|---|---|
| NH₄Cl | 5.4 | g |
| KH₂PO₄ | 1.376 | g |
| Selenite-tungstate Solution | 1 | mL |
| Trace Element Solution | 1 | mL |

Optionally, 2.5 mM Na₂S can be added as a reducing agent/oxygen scavenger if the solution is stored over a prolonged period of time.

The Selenite-tungstate Solution was prepared as a 1 liter aqueous solution using the following compounds:

| Nutrient | per liter H₂O |
|---|---|
| NaOH | 400 mg |
| Na₂SeO₃ × 5H₂O | 6 mg |
| Na₂WO₄ × 2H₂O | 8 mg |

The Trace Element Solution was prepared as a 1 liter aqueous solution containing the following compounds:

| Nutrient | per liter H₂O | |
|---|---|---|
| HCl (25% = 7.7M) | 12.5 | mL |
| FeSO₄ × 7H₂O | 2100 | mg |
| H₃BO₄ | 30 | mg |
| MnCl₂ × 4H₂O | 100 | mg |
| CoCl₂ × 6H₂O | 190 | mg |
| NiCl₂ × 6H₂O | 24 | mg |
| CuCl₂ × 2H₂O | 2 | mg |
| ZnSO₄ × 7H₂O | 144 | mg |
| Na₂MoO₄ × 7H₂O | 36 | mg |

### Example 2

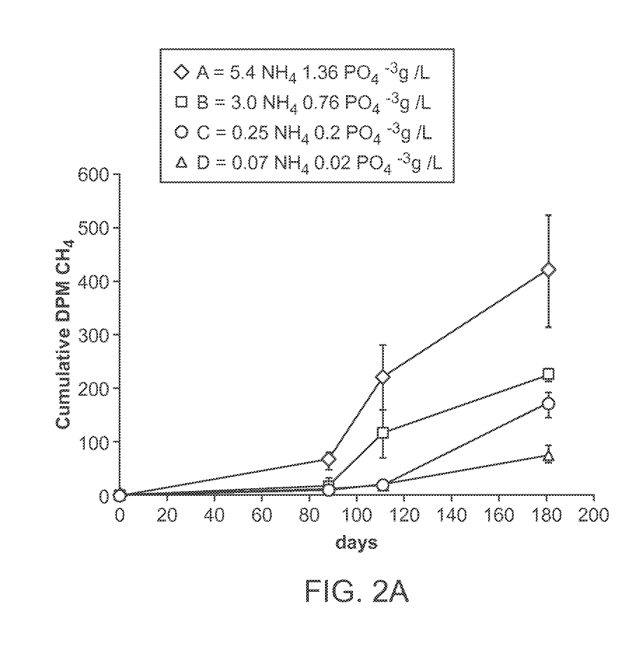

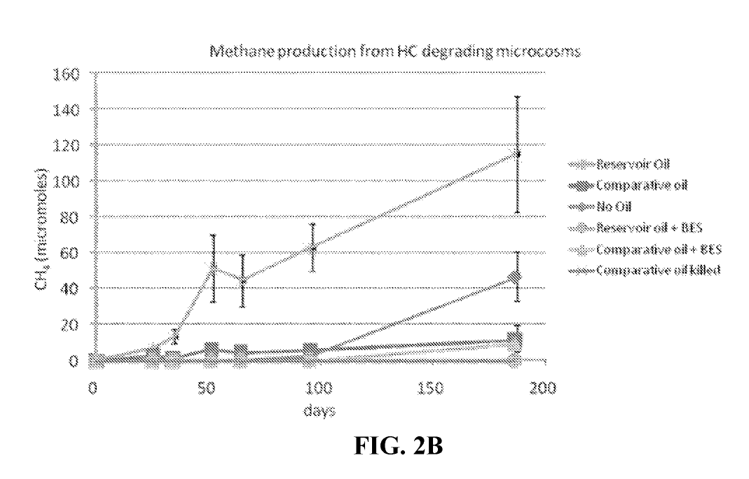

FIGS. 2A and 2B provide examples of significant increases in methanogenesis from the oil of a spent reservoir after injection of nutrients as described below. In particular, the reservoir was selected as it contained methanogenic microorganisms including hydrogenotrophic methanogens (Methanomicrobiales), methylotrophic methanogens (Methanosarcinales) but no, or low numbers of acetoclastic methanogens. In addition the reservoir contained syntrophic methanogenic consortia which converted complex organic carbon (yeast extract) to methane.

A nutrient bolus comprising water and the following nutrients was prepared:

| Nutrient | g/liter H₂O |
|---|---|
| MgCl₂ | 1200 |
| CaCl₂ × 2H₂O | 150 |
| NH₄Cl | 250 |
| KH₂PO₄ | 200 |
| KCl | 500 |
| NaHCO₃ | 2520 |
| FeSO₄ | 2.100 |
| H₃BO₄ | 0.030 |
| MnCl₂ | 0.100 |
| CoCl₂ | 0.190 |
| NiCl₂ | 0.024 |
| CuCl₂ | 0.002 |
| ZnSO₄ | 0.144 |
| Na₂MoO₄ | 0.036 |
| Na₂SeO₃ | 0.006 |
| Na₂WO₄ | 0.008 |

The concentration of each nutrient was adjusted to show the impact of the concentration on methanogenesis as well as the impact that high concentrations had on dispersion of the nutrients into the formation water which resulted in higher rates of methanogenesis.

Specifically, oil from the reservoir as well as formation waters containing endogenous methanogenic microorganisms were combined in the solution described under example 2 except that the ammonium chloride and potassium phosphate concentrations were varied to give a range of ammonium chloride concentrations from 0.07 to 0.54 g/l and potassium phosphate in the range 0.02 to 1.36 g/l (FIG. 2A) ¹⁴C-hexadecane was added and methanogenic degradation of alkanes was followed by monitoring ¹⁴CH₄ produced by the degradation of hexadecane over time. Methane production under anaerobic incubations of formation waters with oil was measured. Different levels of nutrients were added to separate samples and the amount of methane produced measured.

Still further, the total amount of methane produced from 125 mg of Reservoir Oil defined above was compared to control (no oil), comparative oil not suitable for methanogenesis, Reservoir Oil containing BES an inhibitor of methanogenesis as a negative control, comparative oil containing BES, and comparative oil heated to kill any endogenous microorganisms. The results of this analysis are set forth in FIG. 2B.

### Example 3

Using the aqueous nutrient mixture of Examples 1 or 2 above, an excess of the aqueous solution is mixed with oil under agitation until a water in oil emulsion is formed. Emulsion stabilizers such as ethyl cellulose or other well known stabilizers are optionally added to the emulsion to provide for prolonged emulsion stability. Further, a phase transfer catalyst can be added to enhance methanogenesis.

A large excess of foundation water (including the methanogenic microbes) taken from a reservoir as well as a large excess of oil taken from the same reservoir are intermixed in a laboratory setting to form a four phase mixture comprising the water, the water-oil interface, the oil and the gas above the oil. The water in oil emulsion described above is added and the system is closed using a pressure gauge to measure the gas pressure within the system. The system is monitored as the pressure increases due to enhanced methane production.

The contents of the articles, patents, and patent applications, and all other documents and electronically available information mentioned or cited herein, are hereby incorporated by reference in their entirety to the same extent as if each individual publication was specifically and individually indicated to be incorporated by reference. Applicants reserve the right to physically incorporate into this application any and all materials and information from any such articles, patents, patent applications, or other physical and electronic documents.

The methods illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof. It is recognized that various modifications are possible within the scope of the invention claimed. Thus, it should be understood that although the present invention has been specifically disclosed by preferred embodiments and optional features, modification and variation of the invention embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein.

Other embodiments are within the following claims. In addition, where features or aspects of the methods are described in terms of Markush groups, those skilled in the art will recognize that the invention is also thereby described in terms of any individual member or subgroup of members of the Markush group.

1. A method for enhancing methanogenesis in a petroleum reservoir, said method comprising:
introducing a first emulsion proximate to an oil-water interface in the petroleum reservoir, wherein the emulsion comprises oil and water and does not contain surfactants,
wherein the water in said first emulsion comprises one or more nutrients for methanogenic microorganisms; and
wherein the petroleum reservoir comprises an oil layer, a water layer, a gas cap, and a methanogenic microorganism consortium.

2. The method of claim 1, wherein introducing the first emulsion is accomplished by forming the emulsion inside the petroleum reservoir.

3. The method of claim 1, wherein introducing the first emulsion is accomplished by forming the first emulsion outside of the petroleum reservoir and injecting the first emulsion proximate to the oil-water interface.

4. The method of claim 1, wherein introducing the first emulsion is accomplished using horizontal injection.

5. The method of claim 1, wherein the first emulsion is a stable emulsion.

6. The method of claim 1, wherein the first emulsion is a semi-stable emulsion.

7. The method of claim 1, further comprising introducing a second emulsion, wherein the second emulsion comprises oil and water and does not contain surfactants, wherein the water in said second emulsion contains one or more nutrients for methanogenic microorganisms, and wherein the second emulsion is proximate the oil-water interface.

8. The method of claim 7, wherein introducing the second emulsion is accomplished by forming the second emulsion outside of the petroleum reservoir and injecting the second emulsion proximate to the oil-water interface.

9. The method of claim 7, wherein introducing the second emulsion is accomplished using horizontal injection.

10. The method of claim 1, wherein the first emulsion is a stable emulsion.

11. The method of claim 1, wherein the second emulsion is a semi-stable emulsion.

12. The method of claim 1, wherein the first emulsion is a water-in-oil emulsion or an oil-in-water emulsion.

13. The method of claim 7, wherein the second emulsion is a water-in-oil emulsion or an oil-in-water emulsion.

14. The method of claim 7, wherein the first and second emulsions exhibit low gas permeability.

15. The method of claim 1, wherein the one or more nutrients comprise ammonium ions (NH₄⁺) and/or phosphate ions (PO₄³⁻).

16. The method of claim 7, wherein the one or more nutrients in the second emulsion comprise ammonium ions (NH₄⁺) and/or phosphate ions (PO₄³⁻).

17. The method of claim 1, wherein the first emulsion further comprises a phase-transfer catalyst.

18-21. (canceled)

22. The method of claim 7, wherein the local rock topography proximate to the site of the first and second emulsions is sufficiently gas impermeable such that when the consortium produces gas, the local pressure increases sufficiently to allow extraction of oil from the area.

23. A method for repressurizing a petroleum reservoir, said method comprising:
introducing a first emulsion proximate to an oil-water interface in the petroleum reservoir, wherein the emulsion comprises oil and water and does not contain surfactants, and wherein the water in said first emulsion comprises one or more nutrients for methanogenic microorganisms; and
waiting a sufficient time following introduction of the first emulsion to produce a pressure increase of methane in a local area and allow oil recovery from that local area.

24. The method of claim 23, further comprising measuring the pressure exerted by the methane.

25-45. (canceled)
